(19) United States
(12) Patent Application Publication
(10) Pub. No.: US 2013/0212874 A1
(43) Pub. Date: Aug. 22, 2013

(54) METHOD OF MANUFACTURING FUSE ASSEMBLY

(71) Applicant: CHUN-CHANG YEN, Hsinchu City (TW)

(72) Inventor: CHUN-CHANG YEN, Hsinchu City (TW)

(21) Appl. No.: 13/855,728

(22) Filed: Apr. 3, 2013

Related U.S. Application Data
(63) Continuation-in-part of application No. 11/639,208, filed on Dec. 15, 2006, now abandoned.

(51) Int. Cl. H01H 69/02

(52) U.S. Cl. CPC H01H 69/02
USPC 29/623

(57) ABSTRACT

A method of manufacturing a fuse assembly having a main body, two metal legs, and a meltable rod, the meltable rod having two outer ends connected with two inner ends of the metal legs, consisting of following steps: pre-coating a tin layer on an inner surface of respective one of the inner ends of the metal legs; winding the upper ends of the metal legs around the outer ends of the meltable rod; and applying predetermined temperature and pressure on both sides of the inner ends of the metal legs thereby melting the tin layer and completely filling the tin layer between the upper ends of the metal legs and the outer ends of the meltable rod without any space.

### CROSS-REFERENCE TO RELATED APPLICATION

This is a continuation-in-part of the co-pending patent application Serial No. 11/639,208, filed Dec. 15, 2006, owned by the same applicant.

### BACKGROUND OF THE INVENTION

a) Field of the Invention

The present invention relates to a method of manufacturing a fuse assembly, which provides an improved fuse structure to obtain a firm connection between the meltable rod and the upper ends of the metal legs of the main body.

b) Background of the Invention

A conventional fuse for electrical products, as shown in FIGS. 1 and 2, includes a main body (1), two metal legs (2), a meltable rod (3), and a cover (4). Each of the metal legs (2) has an upper end (21) connected with the meltable rod (3) and a lower end (22) connected with an IC board (not shown).

hi order to connect the upper end (21) of the metal leg (2) with the meltable rod (3), it is known that the upper end (21) of the metal leg (2) is winded around the outer end of the meltable rod (3) to form a circular portion with a slit, as shown in FIGS. 3 and 5. Then, tin (5) is applied to the slit of the circular portion and soldered to connect the outer end of the meltable rod (3) to the upper end (21) of the metal leg (2). After cooling, the upper end (21) of the metal leg (2) and the outer end of the meltable rod (3) are connected together, as in FIGS. 4 and 6. However, such connection is not firm enough. As illustrated in FIG. 7, it can be found that tin (5) is not completely filled up the space between the circular portion formed by the upper end (21) of the metal leg (2) and the outer end of the meltable rod (3), thereby making the electrical current unstable when the fuse is used. Hence, it could be easily damaged and the electrical product having this damaged fuse is easily broken at all.

Therefore, it is an object of the present invention to provide a method of manufacturing a fuse assembly which can mitigate and obviate the above-mentioned drawbacks.

### SUMMARY OF THE INVENTION

It is the primary object of the present invention to provide a method of manufacturing an improved fuse assembly to overcome the drawbacks of the prior art, which includes a perfect connection between upper ends of the metal legs and the outer ends of the meltable rod thereby providing stable electrical current and a safe function. Now, accompanying with the following drawings, the characteristics of the present invention will be described in detail hereinafter.

The foregoing object provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded perspective view showing a conventional fuse structure.

FIG. 2 is an assembled view of FIG. 1.

FIG. 3 is a further exploded view of FIG. 1.

FIG. 4 is an assembled view of FIG. 3.

FIG. 5 is an enlarged plan view showing parts of FIG. 1.

FIG. 6 is an enlarged plan view showing parts of FIG. 4.

FIG. 7 is a cross-sectional plan view of FIG. 6.

FIG. 8 is an exploded perspective view showing a fuse assembly manufactured according to the method of the present invention.

FIG. 9 is an assembled view of FIG. 8.

FIG. 10 is an enlarged plan view showing parts of FIG. 8.

FIG. 11 is an enlarged plan view showing parts of FIG. 9.

FIG. 12 is a cross-sectional plan view of FIG. 11.

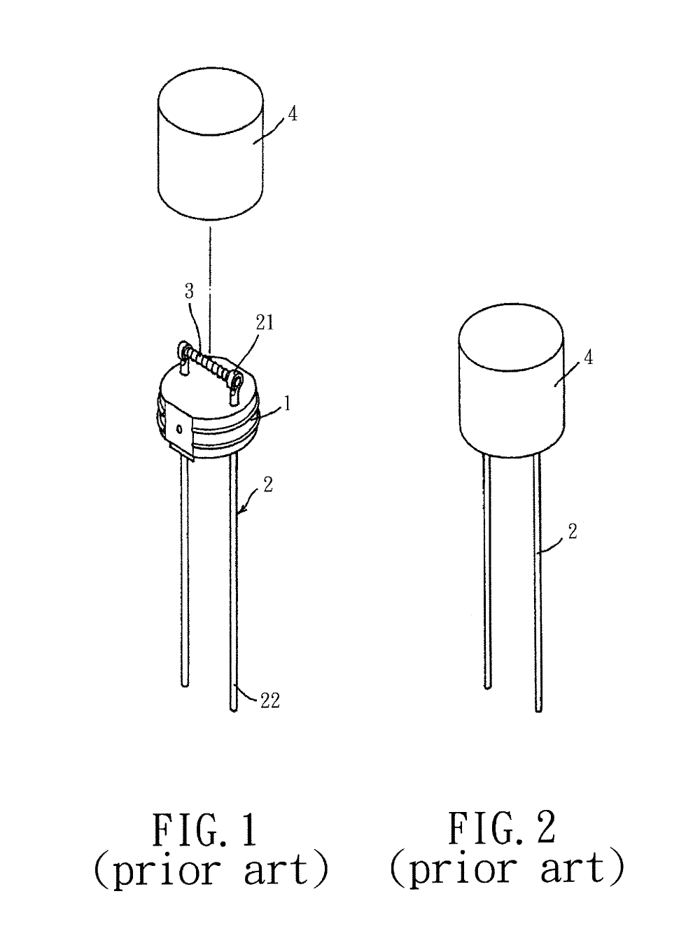

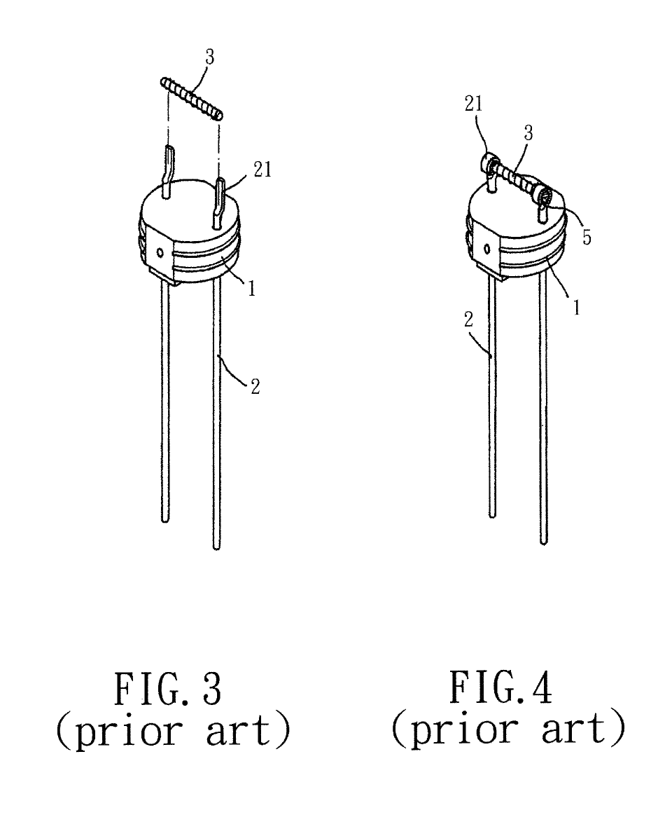

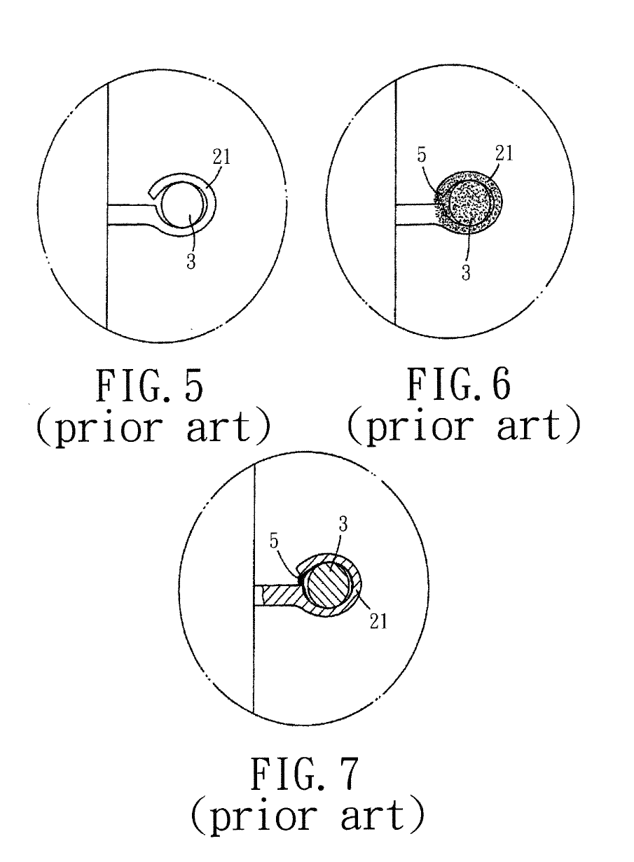

### DETAILED DESCRIPTION OF THE PREFERRED EMBODIMENT

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

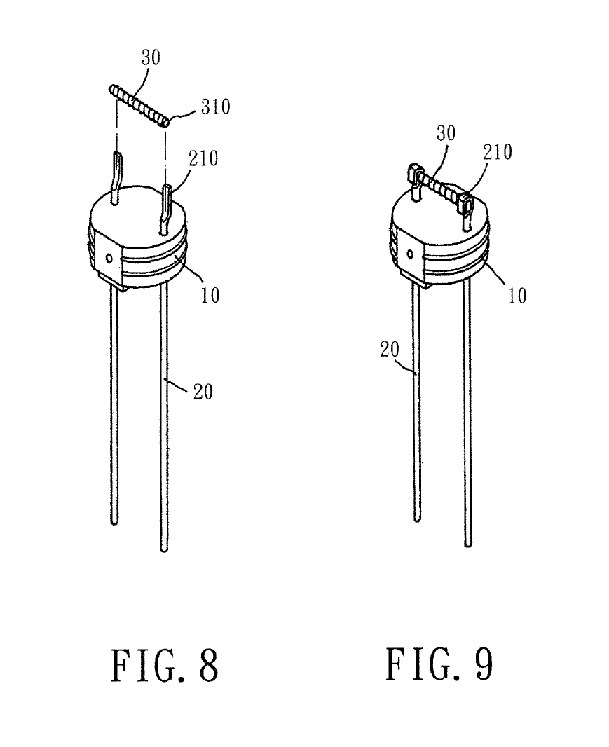

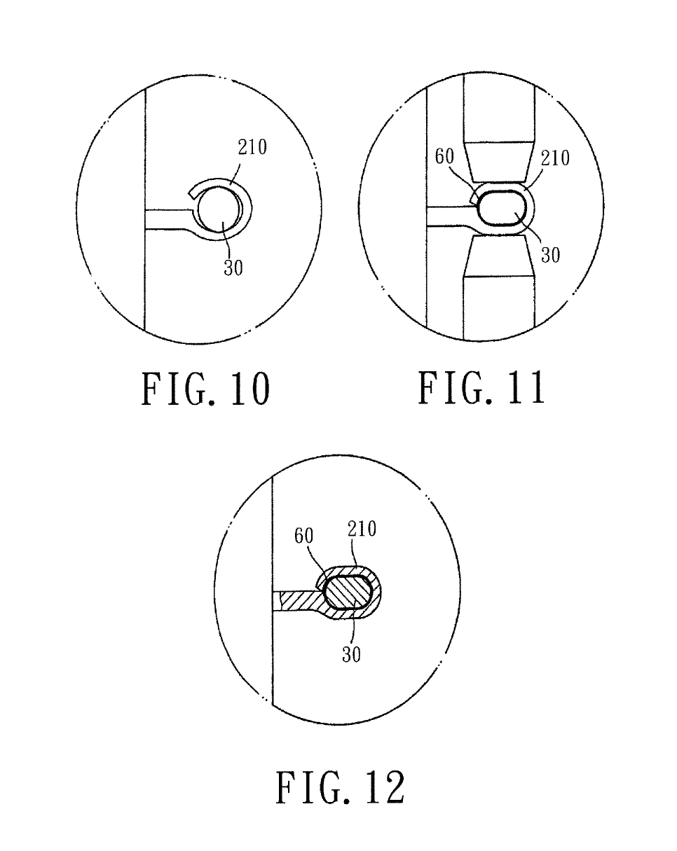

Referring to FIGS. 8 to 12, the present invention relates to a method of manufacturing a fuse assembly which includes a main body (10), two metal legs (20), and a meltable rod (30), the meltable rod (30) having two outer ends (31) each connected to a respective upper end (210) of the metal legs (20). The improvement of the present invention resides in that a thin tin layer (60) is pre-coated evenly on the outer ends (310) of the meltable rod (30). The upper ends (210) of the metal legs (20) can also be pre-coated evenly with a thin tin layer (60).

According to the present invention, the method of manufacturing a fuse assembly having the main body (10), two metal legs (20), and a meltable rod (30), said meltable rod (30) having two outer ends (210) connected with two upper ends (210) of said metal legs, consisting of following steps:
(a) pre-coating a tin layer (60) on an outer surface of said upper ends (210) of said metal legs (20);
(b) winding said upper ends (210) of said metal legs (20) around said outer ends (310) of said meltable rod (30); and
(c) applying predetermined temperature and pressure on both sides of said upper ends (210) of said metal legs (20) thereby melting said tin layer (60) and completely filling said tin layer (60) between said upper ends (210) of said metal legs (20) and said outer ends (310) of said meltable rod (30) without any space.

By applying high temperature and pressure from both sides of the upper end (310) of the meltable rod (30), such as shown in FIG. 11, the tin layer (60) will be melted first and filled all the space between the upper ends (210) of the metal leg (20) and the outer ends (310) of the meltable rod (30). After cooling, the upper ends (210) of the metal leg (20) and the outer ends (310) of the meltable rod (30) can be firmly connected together and the tin layer (60) is fulfilled therebetween without any space. It is to be understood that the fuse assembly obtains a perfect electrical connection. It can be used on any electrical product with a highly effective and stable function.

The method according to the present invention can further consist of a step of evenly pre-coating a tin layer on the upper ends (310) of the metal legs (30) before the upper ends are winded around the outer ends (210) of the meltable rod (20).

The above-mentioned structure is only an embodiment to illustrate my design and is not to limit the scope of this application. Any modified embodiment with similar merits will be still claimed by the present invention.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of manufacturing a fuse assembly having a main body, two metal legs, and a meltable rod, said meltable rod having two outer ends connected with two inner ends of said metal legs, consisting of following steps:
(a) pre-coating a tin layer on an inner surface of respective one of said inner ends of said metal legs;
(b) winding said upper ends of said metal legs around said outer ends of said meltable rod; and
(c) applying predetermined temperature and pressure on both sides of said inner ends of said metal legs thereby melting said tin layer and completely filling said tin layer between said upper ends of said metal legs and said outer ends of said meltable rod without any space.

2. The method of manufacturing a fuse assembly as claimed in claim 1, further consisting of a step of evenly pre-coating said upper ends of said metal legs with a tin layer before the step of winding said upper ends of said metal legs around said outer ends of said meltable rod.
